(19) United States
(12) Patent Application Publication
(10) Pub. No.: US 2017/0184238 A1
(43) Pub. Date: Jun. 29, 2017

(54) Connecting device between a turbine housing of an exhaust turbocharger and a connection housing

(71) Applicant: Neander Motors AG, Kiel (DE)

(72) Inventor: Claus BRUESTLE, Nordheim (DE)

(21) Appl. No.: 15/383,596

(22) Filed: Dec. 19, 2016

(30) Foreign Application Priority Data
Dec. 19, 2015 (DE) 10 2015 016 660.3

(51) Int. Cl. F16L 33/18; F16L 23/00; F16L 17/00; F16L 33/22; F16L 33/00

(52) U.S. Cl. CPC F16L 33/18; F16L 33/22; F16L 33/00; F16L 17/00; F16L 23/00

(57) ABSTRACT

A connecting device is provided between a turbine housing of an exhaust turbocharger and an exhaust manifold housing of an internal combustion engine. The turbine housing and the exhaust manifold housing are kept in position via a band clamp which acts with first and second limbs, which are oriented in a V shaped manner in cross section and are connected via a web, on supporting devices, which are attached to outer circumferences of the turbine housing and of the exhaust manifold housing, and are configured in the manner of first and second ring flanges placed on each other, such that, firstly, first and second clamping surfaces of the limbs are operatively connected to third and fourth clamping surfaces of the supporting devices on first and second connecting planes, and, secondly, first and second radial supporting surfaces are operatively connected to each other on a supporting plane of the supporting devices. An intermediate ring is effective between the second clamping surface of the second limb and an inner supporting surface of the second edge flange. The intermediate ring is clamped against the inner supporting surface of the second ring flange via the second and fourth clamping surfaces and a clamping surface portion of the intermediate ring.

### BACKGROUND AND SUMMARY OF THE INVENTION

The invention relates to a connecting device between a turbine housing of an exhaust turbocharger and a connection housing, preferably an exhaust manifold housing of an internal combustion engine.

An exhaust turbocharger device is known, US 2007/0130943 A1, which comprises a turbocharger with a turbine housing and a central housing. The two housings are assembled at an edge zone thereof with the interposition of a seal. The connecting plane is formed, firstly, by a radial flange of the central housing and, secondly, by a radial end surface of a ring portion of the turbine housing. For the connection of the turbine housing and the central housing, use is made of a clamping band, the V-shaped limbs of which interact with corresponding oblique surfaces of the radial flange and of the ring portion. An inner side of the ring portion is clamped via the clamping band against a peripheral ring element which is clamped against a shoulder of the central housing by means of a supporting projection. A supporting plane between supporting projection and shoulder runs obliquely with respect to a central longitudinal plane of the turbocharger.

U.S. Pat. No. 2,653,836 is concerned with a band clamp which encircles and grips a pair of tubular or cylindrical bodies, specifically in such a manner that they are kept in position in the axial direction. The band clamp has limbs which are V-shaped, as considered in cross section, widened in the direction of a central longitudinal line of the bodies and are connected by means of a connecting web. Said limbs are supported on corresponding annular clamping flanges of the body with a defined force, thus resulting in a liquid- or gas-tight connection.

DE 10 2011 016 223 A1 reveals a band clamp with V-shaped limbs and a connecting web which supports a ring band. The band clamp and the ring band are separated from each other by ends which are at a relatively small distance from each other. Adjacent to the ends, bearing brackets which interact with a clamping bolt are fastened on the ring band.

It is the object of the invention to design a connecting device for a conduction system which conducts hot exhaust gases of an internal combustion engine, comprises a turbine housing and an exhaust manifold housing, can be realized in a structurally simple and lightweight manner and, furthermore, also absorbs high dynamic and thermal loads. However, the connecting device is also intended to be suitable for a conduction system, the turbine housing and exhaust manifold housing of which are groundbreaking with regard to material specification.

According to the invention, this object is achieved by the features of the patent claims.

The advantages primarily obtained with the invention can be considered that of the connecting device setting standards with its sophisticated technical features, namely tension clamps engaging around the ring flanges of the turbine housing and of the exhaust manifold housing in conjunction with the intermediate ring, which is designed as a force transmission element, when used in an internal combustion engine. This connecting device is distinguished here, firstly, in that it superbly withstands even pronounced dynamic forces and temperature effects. Secondly, it should be emphasized that the design and arrangement of the force transmission element or the intermediate ring also create conditions so that different materials can be used for the turbine housing and the exhaust manifold housing. It is thus possible to use ferrous metal for the turbine housing and light metal, composite material or the like for the exhaust manifold housing, which favors the free design of said housing.

An example is how the intermediate ring is clamped via the second limb and the inner supporting surface. Structurally advantageous conditions arise if, in order to form a step-shaped recess between the ring flanges, the second ring flange has a smaller outside diameter from the first ring flange. This assists the configuration of the intermediate ring by the fact that the latter projects with the axial portion into the recess without making contact. The radial portion which is guided away from the axial portion surrounds the clamping surface portion which is operatively connected to the inner support. However, it is also conceivable, with a comparatively good result, for the intermediate ring to have an outer axial portion and a central radial portion which runs with respect to a central longitudinal plane of the turbine housing and in the same direction as the second and fourth clamping surfaces and which is adjoined by an inner radial portion, which inner radial portion has the clamping surface portion which is operatively connected to the inner supporting surface of the second ring flange.

In order to readily absorb the anticipated and demanding loads acting on the connecting device, the intermediate ring is composed of ferrous metal or of another suitable material. For the teleological installation of the intermediate ring, the latter consists of ring halves or ring segments. Finally, the second ring flange of the connecting device can easily be represented by means of a ring-like recess in the exhaust manifold housing.

### BRIEF DESCRIPTION OF THE DRAWINGS

Exemplary embodiments of the invention which are explained in more detail below are illustrated in the drawing, in which:

FIG. 1 shows a view from above of a turbine housing of an exhaust turbocharger and an exhaust manifold housing of an internal combustion engine (not illustrated),

FIG. 2 shows a section according to the line II-II from FIG. 1 on a larger scale with a connecting device having an intermediate ring,

FIG. 3 shows a detail X from FIG. 2 with a first embodiment of the intermediate ring of the connecting device according to FIG. 2,

FIG. 4 shows a second embodiment of the intermediate ring of the connecting device according to FIG. 2,

FIG. 5 shows a main view of the intermediate ring according to FIG. 2 with a first embodiment,

FIG. 6 shows a view according to FIG. 5 with a second embodiment.

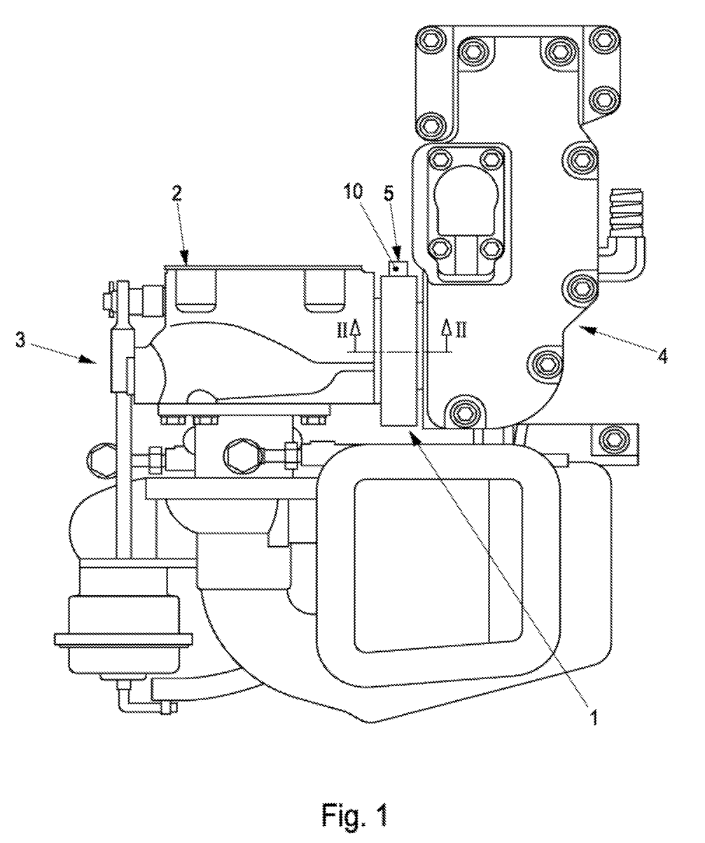

### DETAILED DESCRIPTION OF THE DRAWINGS

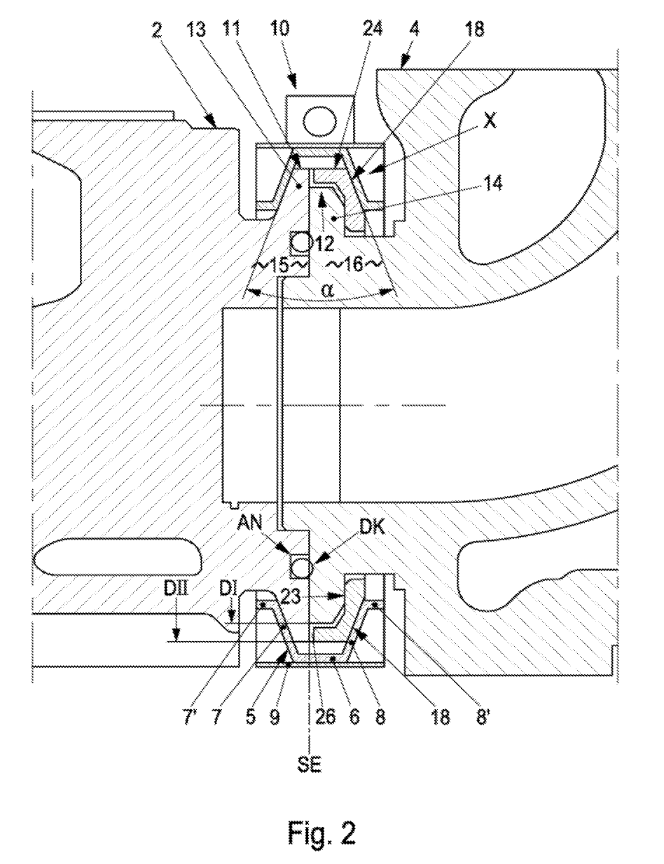

A connecting device 1 for assembling a turbine housing 2 of an exhaust turbocharger 3 with an exhaust manifold housing 4, which are part of an internal combustion engine, comprises a ring-like band clamp 5. The band clamp 5 has first and second limbs 7 and 8 which are oriented in a V-shaped manner—acute angle α—in cross section and are connected by means of a web 6—FIG. 2. Free ends of the limbs 7 and 8 are provided with angled web portions 7′ and 8′. A reinforcing ring 9 is attached fixedly to the outer circumference of the web 6. A lock-like .clamping device 10 with supporting brackets and a clamping screw is attached to ring portion ends of the clamping band—DE 10 2011 016 223 A1.

The first and second limbs 7 and 8 of the band clamp 5 act on supporting devices 15 and 16 which are attached to outer circumferences 11 and 12 of the turbine housing 2 and of the exhaust manifold housing 4, correspond and are designed in the manner of first and second ring flanges 13 and 14 which are placed on each other. For this purpose, firstly, first and second clamping surfaces 17 and 18 of the limbs 7 and 8 are operatively connected to third and fourth clamping surfaces 19 and 20 of the supporting devices 15 and 16 and, secondly, with first and second radial supporting surfaces 21 and 22 on a supporting plane SE of the supporting devices 15 and 16. In the supporting plane SE, an annular sealing body DK rests between the turbine housing 2 and exhaust manifold housing 4, specifically in a recess AN.

An intermediate ring 24 is effective between the second clamping surface 18 of the second limb 8 and an inner supporting surface 23 of the second ring flange 14. Said intermediate ring is clamped against the inner supporting surface 23 of the second ring flange 14 via the second and fourth clamping surfaces 18 and 20 and also a clamping surface portion 25 of the intermediate ring 24.

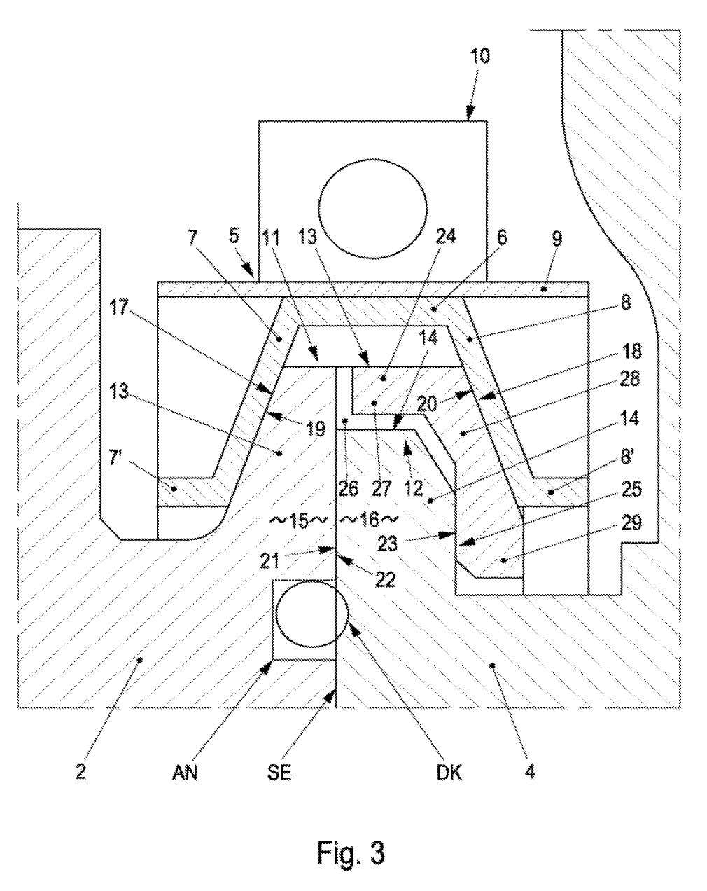

In order to form a stack-shaped recess 26 between the ring flanges 13 and 14, the outside diameter DI of the second ring flange 14 is smaller than the outside diameter DII of the first ring flange 13—FIG. 2. An outer axial portion 27 of a first embodiment—FIG. 3—embodied by an intermediate ring 24, projects into the recess 26. A central radial portion 28 which runs in the same direction as the second and fourth clamping surfaces 18 and 20 extends from said axial portion 27 toward a central longitudinal plane (not shown) of the turbine housing 2. The central radial portion 28 is adjoined by an inner radial portion 29 which has the clamping surface portion 25 and interacts in a supporting manner with the inner supporting surface 23 of the second ring flange 14. The axial portion 27 is arranged in the recess 26 without contact, i.e. without contact with the second ring flange 14 or the first ring flange 13. This also applies analogously to the central radial portion 28.

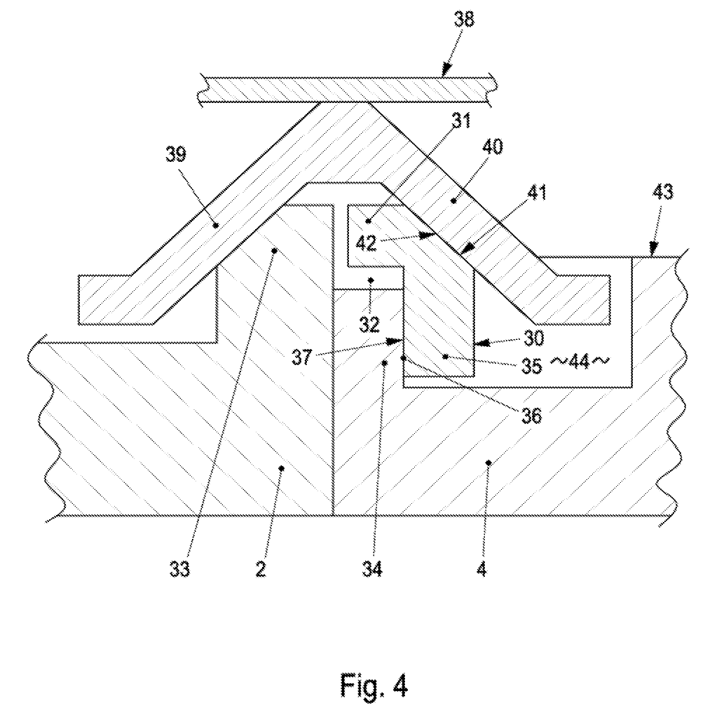

In a second embodiment—FIG. 4—an intermediate ring 30 has an axial portion 31 which projects without contact into a recess 32 between first and second ring flanges 33 and 34. The axial portion 31 together with a radial portion 35 forms an angular construction unit, to the radial portion 35 of which a clamping surface portion 36 is attached; the latter is clamped against an inner supporting surface 37 of the second ring flange 34. This takes place with the aid of a band clamp 38 which is configured similarly to the band clamp 5 with first and second limbs 39 and 40 running in a V-shaped manner with respect to each other. The second limb 40 acts by means of a first clamping surface 41 on a second clamping surface 42 of the intermediate ring 30. In order to form the second ring flange 34, a U-shaped recess 44 is incorporated into an exhaust manifold housing 43.

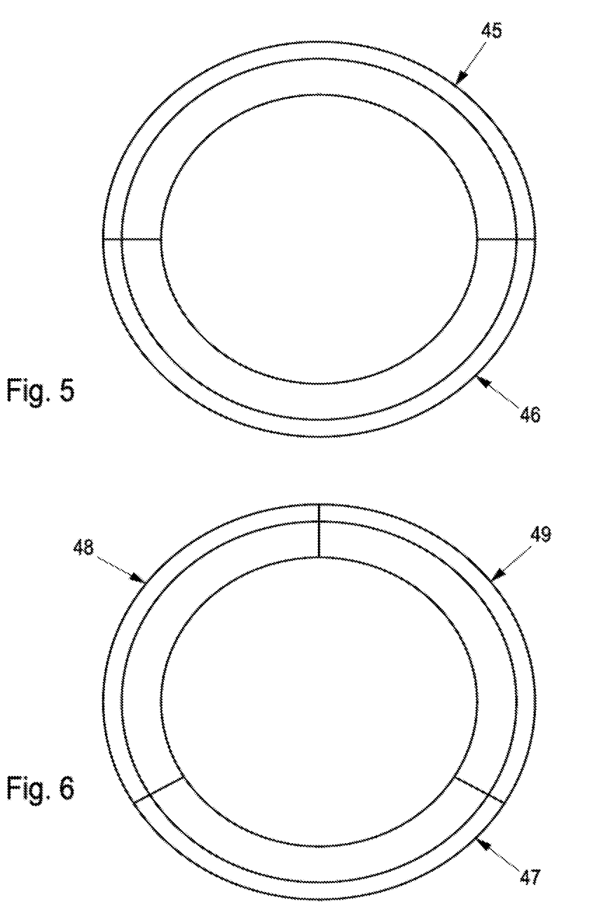

For the installation of the intermediate ring 24 which is composed of steel or of another suitable material, said intermediate ring is composed of ring halves 45 and 46—FIG. 5—or ring segments 47, 48 and 49.

Finally, ferrous metal is suitable as the material for the turbine housing 2, and light metal or a composite material is suitable for the exhaust manifold housing.

1-10. (canceled)

11. A connecting device between a turbine housing of an exhaust turbocharger and a connection housing, comprising:
a band clamp that keeps the turbine housing and the connection housing in position, wherein
the band clamp acts with first and second limbs, which are oriented in a V-shaped manner in cross section and are connected via a web, on supporting devices, which are attached to outer circumferences of the turbine housing and of the connection housing, and are configured in the manner of first and second ring flanges placed on each other,
first and second clamping surfaces of the limbs are operatively connected to third and fourth clamping surfaces of the supporting devices on first and second connecting planes, and,
first and second radial supporting surfaces are operatively connected to each other on a supporting plane of the supporting devices,
an intermediate ring is effective between the second clamping surface of the second limb and an inner supporting surface of the second ring flange, wherein
the intermediate ring is clamped against the inner supporting surface of the second ring flange via the second and fourth clamping surfaces and a clamping surface portion of the intermediate ring.

12. The connecting device as claimed in claim 11, wherein, in order to form a step-shaped recess between the first and second ring flanges, the second ring flange has a smaller outside diameter than the first ring flange.

13. The connecting device as claimed in claim 11, wherein
the intermediate ring has an outer axial portion projecting into the recess and a radial portion which is guided away from said axial portion,
the intermediate ring surrounds the clamping surface portion and is directed toward a central longitudinal plane of the turbine housing and,
the intermediate ring acts with the clamping surface portion on an inner supporting surface and cooperates via a second clamping surface with a first clamping surface.

14. The connecting device as claimed in claim 11, wherein
the intermediate ring has an outer axial portion projecting into the recess and a central radial portion which runs with respect to a central longitudinal plane of the turbine housing in the same direction as the second and fourth clamping surfaces and which is adjoined by an inner radial portion, and
the inner radial portion has the clamping surface portion, wherein
the inner ring is clamped against the inner supporting surface of the second ring flange via the clamping surfaces and the clamping surface portion.

15. The connecting device as claimed in claim 11, wherein
the turbine housing is produced from steel and the connection housing is produced from light metal.

16. The connecting device as claimed in claim 11, wherein
the intermediate ring is composed of steel or of a comparable material.

17. The connecting device as claimed in claim 11, wherein
the intermediate ring is assembled from ring halves or ring segments.

18. The connecting device as claimed in claim 11, wherein
the second ring flange of the connecting device is formed by a ring-like recess in the exhaust manifold housing.

19. The connecting device as claimed in claim 11, wherein the connection housing is an exhaust manifold housing.

20. A connecting device between a turbine housing of an exhaust turbocharger and a connection housing, comprising:
a band clamp that keeps the turbine housing and the exhaust manifold housing in position, wherein
the band clamp acts with first and second limbs, which are oriented in a V-shaped manner in cross section and are connected via a web, on supporting devices, which are attached to outer circumferences of the turbine housing and of the connection housing, and are configured in the manner of first and second ring flanges placed on each other,
first and second clamping surfaces of the limbs are operatively connected to third and fourth clamping surfaces of the supporting devices on first and second connecting planes,
first and second radial supporting surfaces are operatively connected to each other on a supporting plane of the supporting devices,
an intermediate ring designed as a force transmission element is effective between the second clamping surface of the second limb and an inner supporting surface of the second ring flange,
the intermediate ring is clamped against an inner supporting surface of the second ring flange via the second and fourth clamping surfaces between the second limb and the intermediate ring and also a clamping surface portion of the intermediate ring, and
the turbine housing and the connection housing are composed of different materials.

21. The connecting device as claimed in claim 20, wherein
the turbine housing is composed of a ferrous metal,
the connection housing is composed of light metal, composite material, and
the intermediate ring is composed of steel.

22. The connecting device as claimed in claim 20, wherein the connection housing is an exhaust manifold housing.
